(19) United States
(12) Patent Application Publication
(10) Pub. No.: US 2017/0274824 A1
(43) Pub. Date: Sep. 28, 2017

(54) SURVEILLANCE APPARATUS FOR TRANSPORTATION VEHICLE

(71) Applicant: Hitachi Construction Machinery Co., Ltd., Tokyo (JP)

(72) Inventors: Hidefumi Ishimoto, Toride (JP); Yoichi Kowatari, Kasumigaura (JP); Yoshihiro Inanobe, Kasumigaura (JP)

(21) Appl. No.: 15/619,727

(22) Filed: Jun. 12, 2017

Related U.S. Application Data
(63) Continuation of application No. 14/418,978, filed on Feb. 2, 2015.

(30) Foreign Application Priority Data
Aug. 3, 2012 (JP) 2012-172702

(51) Int. Cl. B60R 1/00; H04N 7/18

(52) U.S. Cl. CPC B60R 1/00; H04N 7/181; H04N 7/183; E02F 9/261

(57) ABSTRACT

An object is to bring an operation to recognize precisely situation of an underneath of a vessel provided at a transportation vehicle and rearward situation on the basis of camera image which is attached to the transportation vehicle. Surveillance system of the transportation vehicle according to the present invention comprises a lamp unit 13 mounted at a position under the vessel and rear end of a frame of a dump truck 1, a rearward camera 10B mounted above the lamp unit 13 directing an optical axis toward obliquely downward and having a field of view including at least partially of an axle 11 provided rear wheels 6 of the dump truck 1, a shield plate 16 provided between the lamp unit 13 and the rearward camera 10B to be extended at a position to be included at least partially in the rearward camera 10B, a monitor device provided in the cab 2 of the dump truck 11 to display camera image taken by the rearward camera 10B.

### FIELD OF THE INVENTION

The present invention relates to surveillance apparatus for underneath region of and surroundings of transportation vehicle to transport earth and sand or the like.

### DESCRIPTION OF THE BACKGROUND ART

A dump truck, as a transportation vehicle, has a loading platform (vessel) to be tilted up and down on a vehicle body frame, the vessel is adapted to load substances such as crushed stones, earth and sand, etc. The dump truck is adapted to transport earth and sand to a predetermined collection yard for the sake of discharging the loaded substances. The dump truck goes backward and is stopped at a discharging area. After completion of discharge out of the loaded substances, the vessel is returned to the original position and the dump truck is moved forward.

An operator who is boarded on the dump truck has a visual field for forward direction, but dead angle area is existed other than the forward direction. Therefore, the operator encounters difficulty in confirming with naked eye to areas other than the forward direction. Especially, most of rearward visual field is dead angle for the operator so that the operator cannot confirm the situation of rearward of the dump truck with the naked eye. For this purpose, at lease one camera is attached to the dump truck and a monitor is installed in an operator's cab for displaying the camera image, thereby the operator may be ensured to recognize auxiliary the situation covered with the view angle of the camera.

Specifically, due to the rearward direction being almost entire dead angle, a camera having the view angle should be provided for the rearward direction of the dump truck. The operator can be included into visual field of the rearward situation which is almost dead angle. The camera is taking image continuously at a predetermined cycle and is transferred camera images at every imaging cycle. Thereby, the monitor is displayed the rearward situation of the dump truck as video image which is dead angle, as a result being adapted to assist for the operation of the dump truck by the operator.

As a dump truck, a normal dumper and a large scaled dump truck are implemented, in case of large in size, underneath region of the vessel is formed expansive space. Especially, in a case of a large scaled dump truck having loading capacity of over 100 ton, the underneath space of the vessel has extremely large space. Therefore, any obstacle is indeed liable to enter the underneath space of the vessel. The dump truck is restricted to travel in view of security in such a case.

Thus accordingly, it is important, not only to recognize the operator to take an image of the rearward of the dump truck, but also to recognize the situation of the underneath of the vessel for the operator. The vessel which is loaded earth and soil is tilted on discharging the load, for this reason, the camera which is taken image to the rearward of the dump truck is normally unable to install on the vessel. For this reason, techniques to be attached the camera to a rear frame is disclosed in Patent Document 1. According to the Patent Document 1, a rear combination lamp is mounted on the rear frame, the camera is mounted at the position upper than the rear combination lamp. The field of vision range of the camera is extended to underneath area over the rearward of the dump truck.

### PRIOR ART DOCUMENT

### Patent Document

Patent Document 1: JP 2011-168163 A1

### SUMMARY OF THE INVENTION

### Problem to be Solved by the Invention

According to the techniques of the Patent Document 1, the camera is mounted above position of the rear combination lamp, and the field of vision of camera being able to direct toward rearward and underneath region. By constructing so, underneath region of the vessel can be included in the field of vision of the camera, in addition to the rearward of the dump truck. However, during lighting of the rear combination lamp, emitted light from the rear combination lamp is directly entered into the lens of the camera. When the emitted light from the rear combination lump enters directly into the camera, the incident light becomes harmful light, resulting the image taken by the camera becoming unnatural image.

Therefore, image displayed on a monitor transferred from the camera is also unnatural state, the operator cannot recognize underneath region of the vessel and rearward direction of the dump truck precisely. The rear combination lamp can be utilized as illumination light in night. In a case that the illumination light intensity becomes high, image taken by the camera is affected by the incident light from the rear combination lamp. The thus captured image is resulted to hardly be recognized image, thereby the operator cannot confirm the situation underneath of the vessel and rearward.

The present invention has an object to be recognized by an operator precisely underneath and rearward situation of a transportation vehicle on the basis of a camera provided on the transportation vehicle.

### Means for Solving the Problem

In order to solve the foregoing problem, surveillance apparatus for transportation vehicle of the present invention comprising: a lamp unit mounted to a frame rear end position of the transportation vehicle at under position of a vessel; a rearward camera installed at a position above the lamp unit, visual field thereof being included at least partially of an axle for rear wheels of the transportation vehicle, and taking image of the rearward direction of the transportation vehicle directed the optical axis toward obliquely downward direction; a shield member provided at a position between the lamp unit and the rearward camera, and extended to a position corresponding to be covered at least partially the axle within the visual field of the rearward camera; and a display device provided in a cab of the transportation vehicle to show rearward camera image taken by the rearward camera.

In addition, the rearward camera may have an angle of view including partially of the rear end of the axle, and the shield member may be extended to the position to have the angle of view including partially of the rear end of the axle.

The apparatus may further be comprising of a left side camera to take image of the left side of the transportation vehicle and a right side camera to take image of the right side of the transportation vehicle, both the optical axis toward obliquely downward, a view point conversion section to create individual bird's eye images from the images at least taken by the rearward camera, the left side camera and the right side camera to convert their view points to upper view points, a composite bird's eye view image creating section to compose a symbol image which is symbolized the transportation vehicle and respective individual bird's eye images disposed surrounding thereof, thereby displaying the rearward camera image and the composite bird's eye view image on a screen of the display device being divided into respective display areas.

Further, screen is divided into several divided display areas and the divided display areas of the screen may be displayed a enlarged rearward camera image enlarged the portion of the axle including between the right and left rear wheels in place of the rearward camera image, and the composite bird's eye view image.

Furthermore, on the divided display areas of the screen may be displayed a enlarged rearward bird's eye image converted by the view point conversion section of the rearward camera image enlarged the portion of the axle including between the right and left rear wheels in place of the rearward camera image, and the composite bird's eye view image.

### Effects of the Invention

According to the present invention, the rearward camera which is directed the optical axis toward obliquely downward direction is installed at the position above the lump unit, thereby the visual field being enlarged to broader area of underneath the transportation vehicle. The shield member is provided between the lamp unit and the rearward camera, thereby light emitted from the lamp being avoided to incident directly to the rearward camera. The shield member is restricted to enter at least partially the axle into the rearward camera, thereby ensuring to display the necessary area of underneath of the vessel.

### BRIEF DESCRIPTION OF THE DRAWINGS

FIG. 1 is a left side elevation view of a dump truck.

FIG. 2 is a plane view of the dump truck.

FIG. 3 is a rear side elevation of the dump truck.

FIG. 4 is a perspective view of the rear end portion of the dump truck omitted a vessel.

FIG. 5 shows an example of disposition of a rearward camera.

FIG. 6 shows a tilted status of the vessel.

FIG. 7 shows an example of a cab.

FIG. 8 shows a block diagram of a display controller and components to be connected thereto.

FIG. 9 is a principle explanation for processing a view point conversion.

FIG. 10 shows an example of image taken by a rearward camera.

FIG. 11 shows an example of monitor screen at the time of showing a rearward camera image and a composite bird's eye view image simultaneously.

FIG. 12 shows an example of monitor screen at the time of showing an enlarged rearward camera image and a composite bird's eye view image simultaneously.

FIG. 13 shows an example of monitor screen at the time of showing a rearward camera image and a composite bird's eye view image simultaneously.

### EMBODIMENT OF THE INVENTION

Hereafter, embodiments of the present invention will be described with reference to drawings. In the following example the description is made for a dump truck as transportation vehicle, but not to be restricted to the dump truck. The dump truck 1 includes a rigid type and an articulated type, whichever type can be applied. In the embodiment, “left” means the left side view from an operator's cab, and “right” means the right side view from the operator's cab.

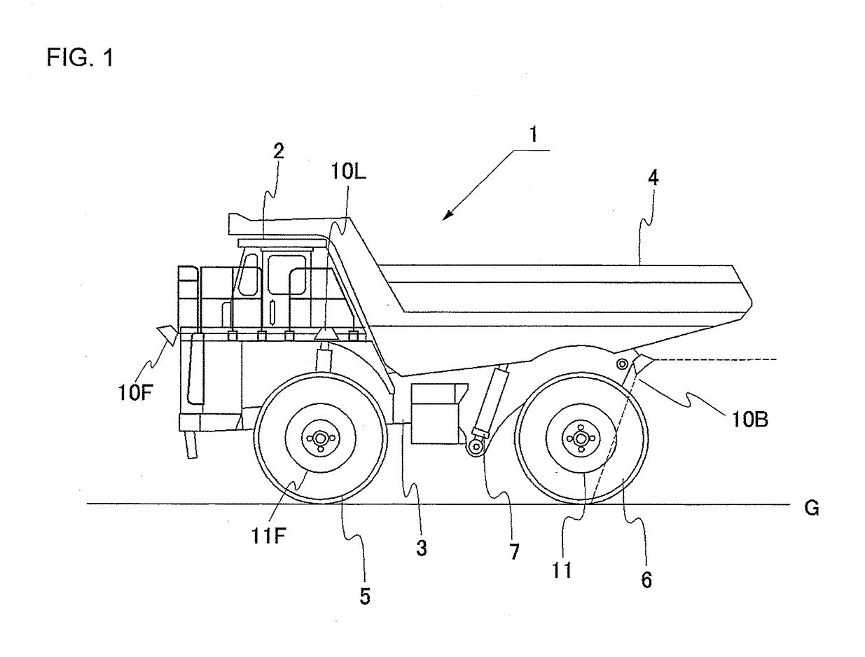

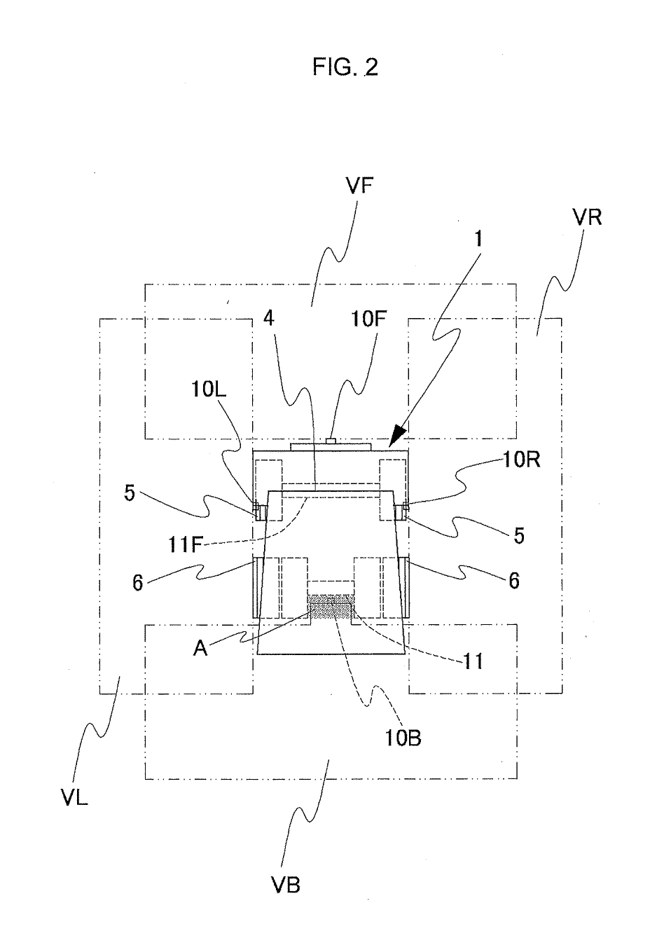

FIG. 1 shows the left side elevation of the dump truck 1 and FIG. 2 shows the plan view thereof. As shown in these drawings, the dump truck 1 comprises a cab 2, a frame 3, a vessel 4, front wheels 5 and rear wheels 6, and a driving cylinder 7. The forward side, rearward side, left side and right sides of the dump truck 1 are provided with cameras 10 (forward camera 10F, right side camera 10R, left side camera 10L and rearward camera 10B), and images taken by respective cameras are outputted as camera images.

The field of view of these cameras are obliquely downward direction, respectively, toward forward direction for the forward camera 10F, toward rearward direction for the rearward camera 10B, toward rightward direction for the right side camera 10R and toward leftward direction for the left side camera 10R. In this connection, arbitral number of cameras 10 may be installed on the dump truck 1. However, it is preferred to be installed the rearward camera 10B, the right side camera 10R and the left side camera 10L due to take image toward the dead angle for the operator. In a case of an articulated type dump truck, still more number of cameras may be installed.

A cab 2 which is provided for boarding the operator to operate the dump truck 1 is normally placed at the left side at the dump truck 1. Various operating means are arranged in the cab 2. The frame 3 constitutes a truck frame, the front wheel 5 is provided at the fore side of the frame 3 and the rear wheel 6 is provided at the rear side thereof. The vessel 4 is a platform which is loaded with earth and sand, ore or the like. The vessel 4 is connected to the driving cylinder 7 and the link mechanism 8 for tilting action. Thereby, loaded earth and sand or the like can be discharged out from the vessel 4.

FIG. 2 shows a plan view of the dump truck 1. The dump truck 1 is provided a pair of front wheel 5, respectively at right and left sides, and a front side axle 11F is connected to the opposite front wheels 5. On the contrary, the rear wheels 6 which are consisting of two pieces are mounted for the dump truck 1 at right and left positions, these are attached at the opposite ends of a rear side axle 11. Hereinafter, the rear side axle 11 is simply referred as axle 11.

In the drawing, the regions to be indicated within phantom line are defined as field of views of respective cameras 10. Rearward view region VB is the view area of the rearward camera 10B, forward view region VF is the view area of the forward camera 10F, right side view region VR is the view area of the right side camera 10R and left side view region VL is the view area of the left side camera 10L. The rearward camera 10B is provided with a wide angle lens, the field of view has the rearward of the dump truck 1, in addition, being included within the field of view the axle 11 which is positioned at the foreside of the rearward camera 10B. In other words, the rearward camera 10B has a field of view including a space A defined by the inner sides of the opposite rear wheels and the axle 11. The space A is resided underneath area of the vessel 4.

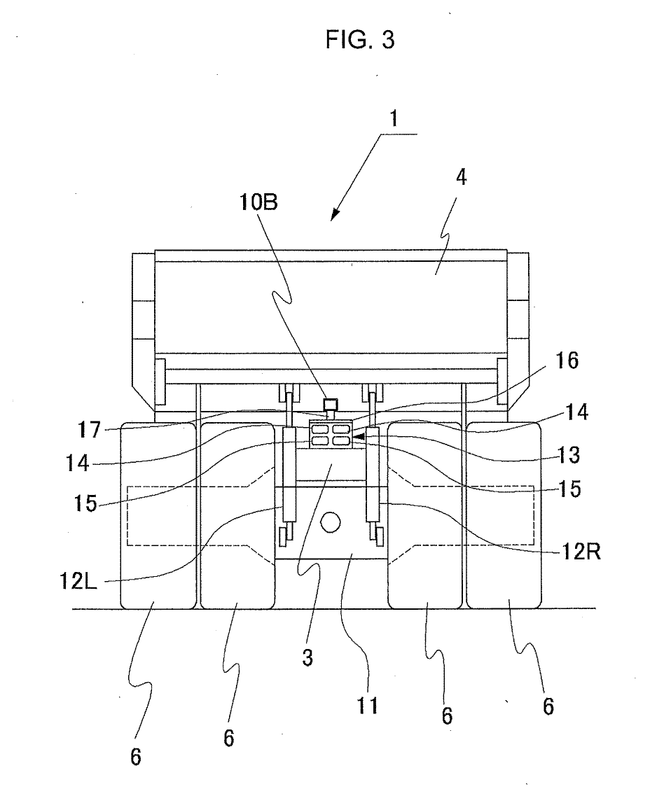

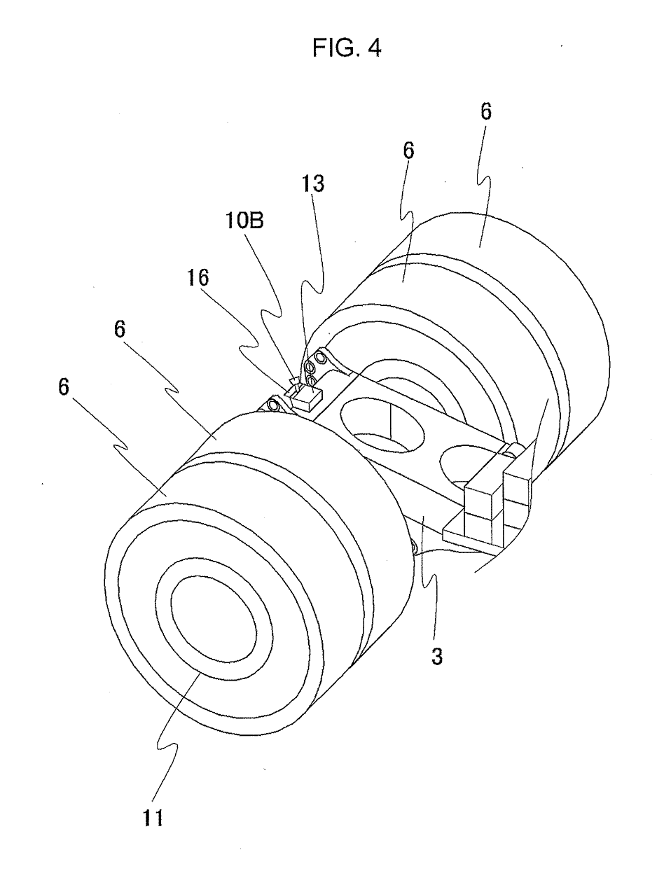

FIG. 3 shows a rear side elevation of the dump truck 1. As is apparent from this figure, the vessel 4 is provided above the frame 3. Further, a pair of link mechanism 12L, 12R are connected between the frame 3 and the vessel 4. FIG. 4 shows the rear portion of the dump truck 1 omitted the vessel 4. As apparent from this figure, the rear end of the frame 3 is extended over the rearward position of the axle 11 at the forward position of the rear end of the rear wheel 6. Further, a lamp unit 13 is mounted on the rear end of the frame 3.

The lamp unit 13 consists of several kinds of lamps. As an example, two winker lamps 14 and two back light lamps 15 are shown in FIG. 3. The winker lamp 14 is emitted light not so high density, while incident light emitted from the back light lamp 16 is high density. A shield plate 16 is mounted at a position above the lamp unit 13. The shield plate 16 is extended to rearward direction from the end of the lamp unit 13. A camera mount 17 is provided at an upper position from the shield plate 16, the rearward camera 10B being attached to the camera mount 17.

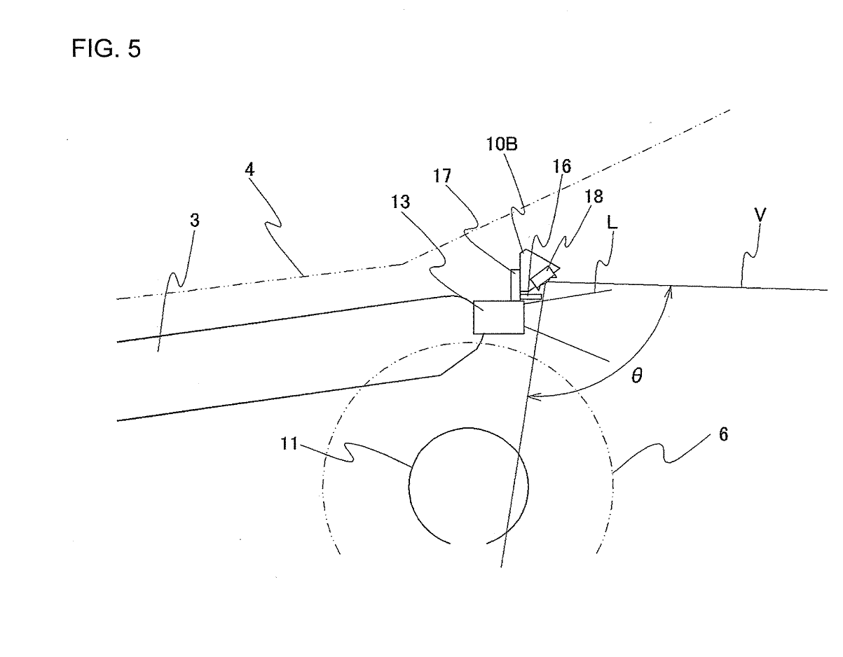

FIG. 5 shows an explanation about the rearward camera 10B. In this figure, a lens 18 is shown for the rearward camera 10B. The lamp unit 13 is provided at the rear end of the frame 3, and the rearward camera 10B is mounted on the camera mount 17. The angle of view (field of view) has a property of wide as indicated θ for the lens 18 of the rearward camera 10B in this figure. Under this circumstance, projected light L as shown in this figure is emitted from the winker lamp 14 and back light 15. The shield plate 16 has a function to block the light L not to enter into the rearward camera 10B.

The rearward camera 10B is composed of wide angle lens 18, thereby the field of view including not only the rearward direction of the dump truck 1 but also underneath region of the vessel 4. Under this situation, the rearward camera 10B has a field of view including into visibility of the axle 11 at least partially (or fully). As previously explained, the emitted light L does not enter into the rearward camera 10B by the presence of the shield plate 16. However, the shield plate 16 has a function to make narrow the angle of view for the rearward camera 10B. In other words, the shield plate 16 restricts the visual field of the rearward camera 10B. Therefore, the shield plate 16 is extended to the position that at least a part of the axle 11 is included in the visual field of the rearward camera 10B.

Hereafter, the position of the rearward camera 10B is explained. The left and right sides of the rearward camera 10B (the left and right sides of the dump truck 1) defines the rear end of the frame 3. In other words, its position is arranged between the inner position of the opposite rear wheels. In particular, it is preferable to dispose the rearward camera 10B at approximately center in the foregoing direction. By so constructing, the image taken from the rearward camera 10B is brought into concentric and symmetrical state.

The position from front to rear direction of the rearward camera 10B (the forward and backward directions of the dump truck 1) is located at the forward place of the rear wheel 6. The work field to travel the dump truck 1 is uneven ground, the rear wheel 6 is likely to cause jumping up mud, sand, stone and the like from the ground. The scattering direction is mainly toward the rearward of the rear wheel. Since the rearward camera 10B is placed between the inner sides of opposite rear wheels and forward position from the rear ends of the rear wheels, mud, sand, stone and the like are hardly to cause damage for the rearward camera 10B.

Further, the position in the front to rear direction of the rearward camera 10B is located the forward position of the rear wheel 6 as explained above, in addition at the rearward position to the axle 11. As regarding the position in the height direction, it is desired to be positioned at the highest position on the condition not to contact with the vessel 4. Accordingly, the rearward camera 10B is positioned rearward at higher as much as possible, provided under the foregoing conditions. Thereby, the rearward camera 10B may be included into the field of view more widely underneath of the vessel 4.

In addition, the position in the front to rear direction of the rearward camera 10B is disposed at forward position than the rear end of the rear wheel 6 as explained above. Therefore, the distance between the rearward camera 10B and the axle 11 is increased in the longitudinal direction accordingly. As a result, the axle 11 can be included in the field of view by the rearward camera 10B, even though the angle of view being not so widened.

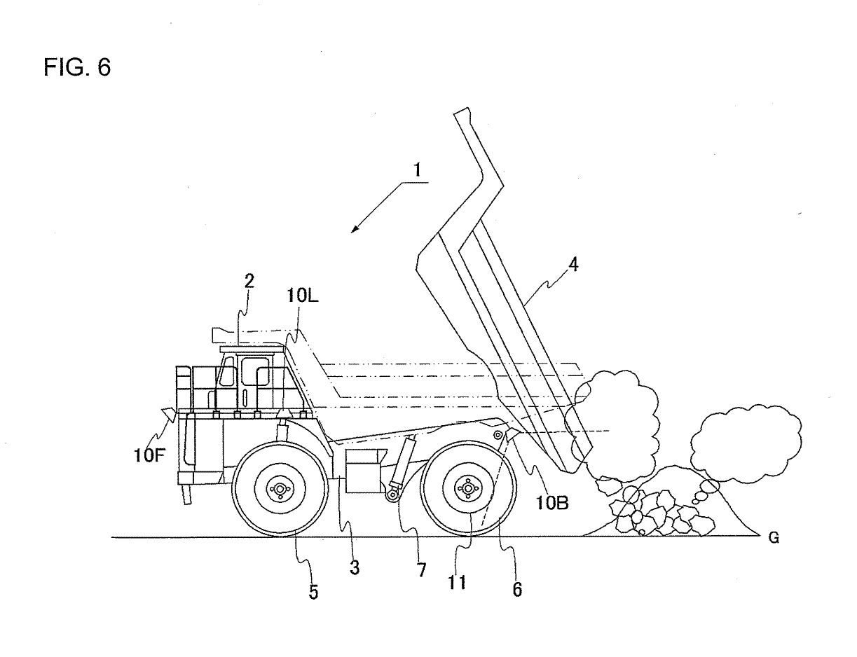

The dump truck 1 discharges earth and sand loaded on the vessel 4. At the time of discharging earth and sand from the vessel 4, the vessel 4 is tilted to the maximum angle. The rearward camera 10B stays forward of the vessel 4 at the time of discharging. At the time being discharged earth and sand, the discharged subject is jump up from the ground. However, as shown in FIG. 6, the rearward camera 10B is placed forward of the vessel 4, thus accordingly the vessel 4 is facilitated to protect the rearward camera 10B from the discharged jump up subjects. Thereby, the rearward camera 10B can be prevented from damage or adhesion of dust and the like.

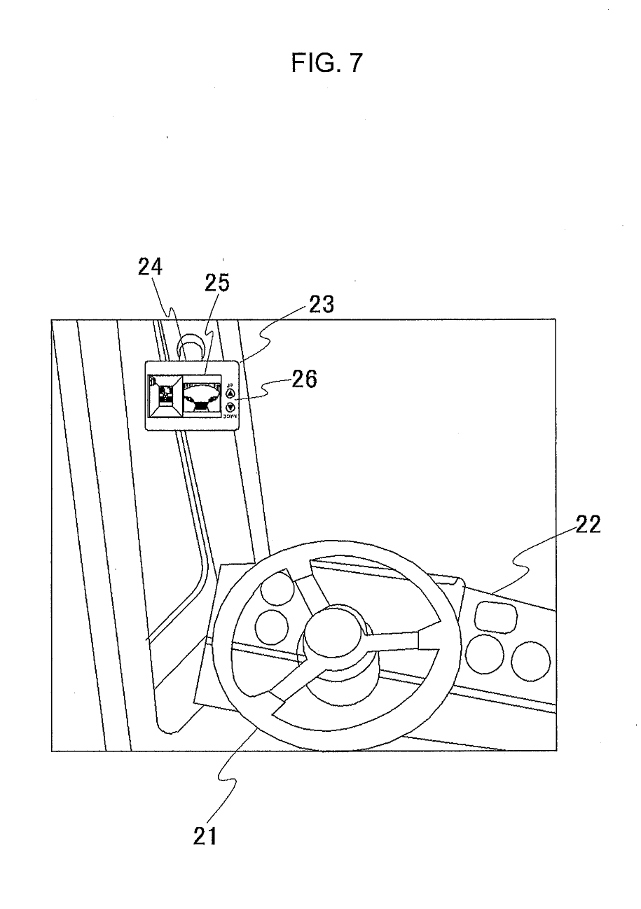

FIG. 7 shows an example of the cab 2 to be boarded by the operator. The cab 2 is provided a handle 21 to be operated by the operator for traveling, a consol 22 to display various meters and a pillar 23. A monitor 24 is attached to the pillar 23. The monitor 24 is a display device consisting of a screen 25 and an input part 26. The screen 25 is a display screen to show specific information and the input part 26 is provided for appropriately controlling the contents of the screen 25. In this connection, the monitor 24 is adapted to be mounted arbitrary position in the cab 2, and the input part 26 can be omitted by the screen 25 being constituted as a touch panel.

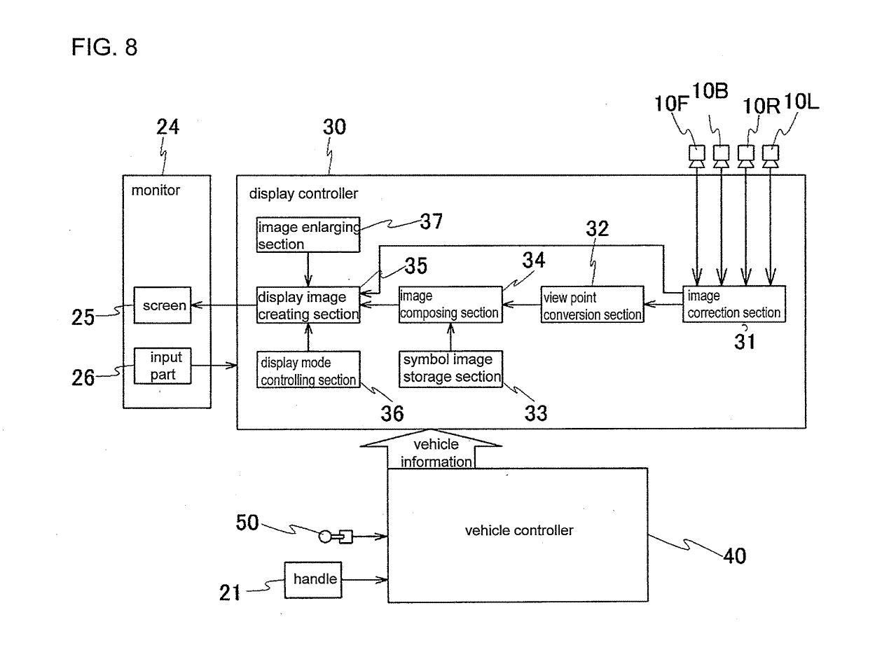

FIG. 8 shows a display controller 30 which is processing in accordance with predetermined treatment of the camera image of respective cameras 10 provided at forward, rearward, right and left sides. The display controller 30 is connected to a vehicle controller 40. The display controller 30 comprises an image correction section 31, a view point conversion section 32, a symbol image storage section 33, a image composing section 34, a display image creating section 35, a display mode controlling section 36 and an image enlarging section 37. The respective sections of the display controller 30 may be achieved by a software and the functions of the respective section on the basis of CPU.

The image correction section 31 is inputted image data from the forward camera 10F, the rearward camera 10B, the right side camera 10R and the left side camera 10L. And, the inputted image data are subjected to perform various image corrections such as aberration correction, contrast correction, color tone correction and so on based upon parameters for camera optical system and the like. Thereby, the input image can be improved the image quality. The corrected image in the image correction section 31 is outputted to the view point correction section 32 as a camera image (through image). That is to say, four camera image consisting of a camera image of forward direction (forward camera image), of a camera image of rearward direction (rearward camera image), of a camera image of right side direction (right side camera image) and of a camera image of left side direction (left side camera image) are outputted to the view point conversion section 32. Further, the rearward camera image in these camera images is outputted to the display image creating section 35.

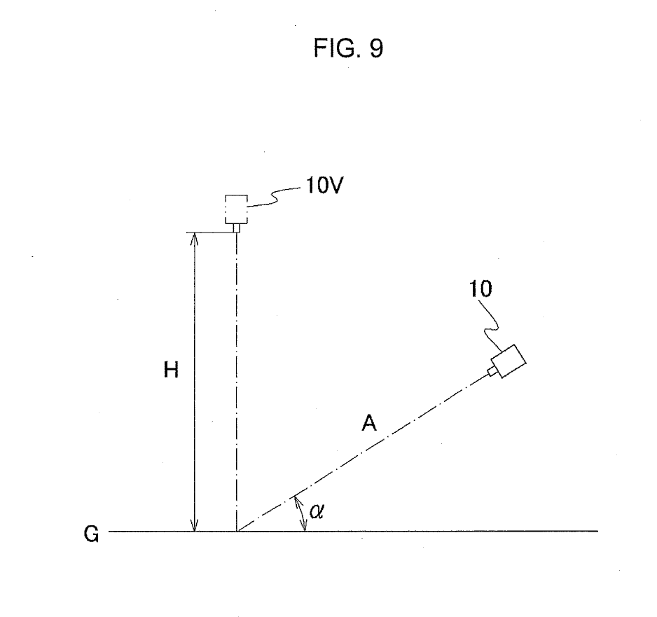

The view point conversion section 32 performs a process for the view point conversion for the image data which is entered from the image correction section 31 to create bird's eye view image (virtual view point image). As described hereinbefore, respective cameras 10 are directed the optical axis to obliquely downwardly for making conversion to virtual view point from upper position to downwardly. As shown in FIG. 9, the optical axis A of objective lens of cameras 10 (front side camera 10F, right side camera 10R, left side camera 10L and back side camera 10B) have a predetermined angle θ with respect to the grand level L, therefore the optical axis of the cameras 10 are directed obliquely downwardly. According to the view point conversion section 22, a virtual camera 10V is virtually set at height H with the vertical optical axis, and the coordinate is converted to view from the virtual camera 10V to the ground surface level L. The image which is converted to the upper view point is virtual plan view (bird's eye view image).

Accordingly, the view point conversion section 32 converts to create forward bird's eye view image from forward camera image, to create rearward bird's eye view image from rearward camera image, to create right side bird's eye view image from right side camera image and to create left side bird's eye view image from left side camera image. The view point conversion section 32 outputs these four bird's eye view images as individual bird's eye images to the image composing section 34.

The image composing section 34 is inputted the four bird's eye images from the view point conversion section 32 and also inputted the symbol image from the symbol image storage section 33. The symbol image storage section 33 stores symbol image data, the symbol image is an image to display on the screen 25 as a symbol (character) of the dump truck 1. Thus, the symbol image is a reproduction image of contour of the dump truck 1. By making high reproducibility, the operator can exactly recognize the feature of the dump truck 1. However, the high reproducibility of the dump truck is not essentially necessary factor. As a diagram or the like can be used as the symbol image provided that the image is capable of being recognized as a dump truck 1.

The image composing section 34 performs process to compose four bird's eye images around the symbol image. Around the symbol image, there are placed forward side bird's eye image at the forward side position, the rearward side bird's eye image at the rearward side position, the right side bird's image at the right side position and the left side bird's eye image at the left side position, respectively. Thereby, a composite bird's eye view image is created that the respective individual bird's eye images are disposed around the symbol image at forward, rearward, right side and left side positions. The image composing section 34 outputs to the display image creating section 35 thus created composite bird's eye view image.

The display image creating section 35 prepares image to be displayed on the screen 25 of the monitor 24. The display image creating section 35 is inputted rearward camera image from the image correction section 31 and the composite bird's eye view image from the image composing section 34. The rearward camera image can be displayed on the screen 25, or in place thereof the rearward camera image and the composite bird's eye view image are adapted to simultaneously display on the screen 25 as a condition to divide the display area. The display image creating section 35 creates the display image to be displayed on the screen 25.

The display mode controlling section 36 performs to control the mode to be displayed view image on the screen 25. As explained foregoing, the rearward camera image may solely be shown on the screen 25, or the rearward camera image and composite bird's eye view image are able to be displayed simultaneously on the screen 25. The display mode controlling section 36 can be controlled for the display image creating section 35 by operating the input part 26.

The image enlarging section 37 is facilitated to enlarge partially of the rearward camera image or the composite bird's eye view image which is inputted into the display image creating section 35. Therefore, at the time of performing the image enlargement in accordance with the image enlarging section 37, the screen 25 is shown rearward camera image with enlarged scale (enlarged rearward camera image) or the composite bird's eye view image with enlarged scale (enlarged bird's eye view image). Explanation of the extent in the rearward camera image or composite bird's eye view image will be brought up at the following portion. Thus, the rearward camera image, composite bird's eye view image or their enlarged image is shown on the screen 25 for reviewing of the operator.

As shown in FIG. 8, the display controller 30 is connected to the vehicle controller 40. The vehicle controller 40 is connected to various operating means for controlling the dump truck 1. A shift lever 50 is one means to be connected thereto. The shift lever 50 is a traveling operation means to control about traveling of the dump truck 1, and is adapted to shift for three positions consisting of forward position, neutral position and backward position. At the time of the shift lever 50 being placed at the forward position, the dump truck 1 runs forward direction, while at the backward position, the dump truck 1 being caused of backward direction, further at the neutral position, the dump truck 1 being stopped. The shift lever information as to the status of the position of the shift lever 50 (forward, neutral or backward) is outputted to the vehicle controller 40. Further, the shift lever information is transferred to the display controller 30 as a vehicle information.

The foregoing description is made for the construction. Hereafter is referred to as operation. In this connection, the explanation is referred to two display modes of a first display mode and a second display mode in a screen 25 of the monitor 24. The first display mode shows the rearward camera image on the screen 25, while the second display mode shows rearward camera image and composite bird's eye view image at the same time by being divided the screen 24. As a matter of course, any other display mode than the first display mode or the second display mode may be shown. In the first place, the explain is described for the first display mode.

It is necessary to take image in the rearward camera 10B for displaying the rearward image on the screen 24. For this purpose, the operator boarded in the cab 2 should operate at least the engine or the like, thereby starting to take image for the rearward camera 10B. The rearward camera 10B is installed above the lamp unit 13 at the rear end of the frame 3, and being directed toward underneath of the vessel 4. Therefore, the rearward camera 10B can be taken image of the rearward direction of the dump truck 1 and underneath of the vessel 4.

As explained before, the rearward camera 10 has a wide-angle lens 18 in the view range V having the angle θ as shown in FIG. 5. The rear end portion of the axle 11 is thus included in the view field of the rearward camera 10B. In this connection, the view field is included the full range of the axle 11 in the longitudinal direction, but it is sufficient to include in the field of view at least partially (at the rear end) of the axle 11 in the longitudinal direction. Thereby, a space A is included in the field of view between the axle 11 and the opposite rear wheels 6. The rearward camera 10 may include the full length of the axle 11 into the field of view, thus resulting correspondingly to enlarge the angle of view. Therefore, it is desired to be partially included the axle 11 into the field of view.

As shown in FIG. 5, the image taken by the rearward camera 10B is inputted to the image correction section 31. The image correction section 31 performs predetermined process to the inputted image from the rearward camera 10B for improving the quality of image from the rearward camera 10B. The rearward camera image thus improved the quality is outputted to display image creating section 35.

In accordance with the first display mode, the display mode controlling section 36 controls to display the rearward camera image on the screen 25. For this purpose, the operator carried out to select the first display mode by means of, for example, the input part 26. Thereby, the display mode controlling section 36 can recognize to select the first display mode, as a result, the screen 25 is displayed rearward camera image which is selected by the input of the display mode selecting section 36.

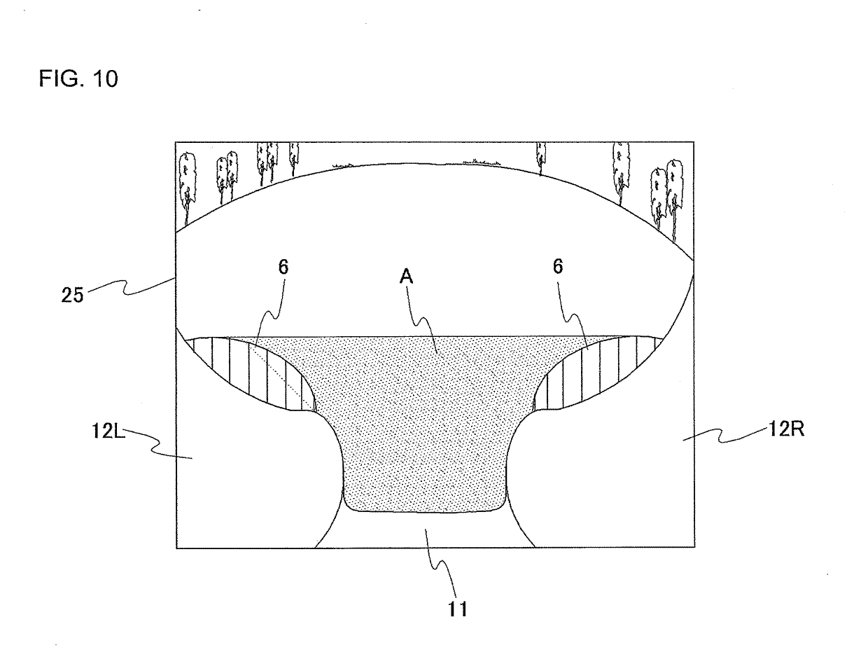

FIG. 10 shows an example of rearward camera image to be displayed on the screen 25. The rearmost position of the dump truck 1 is placed the vessel 4, the rearward camera 10B being not attached to the vessel 4. As shown in FIG. 5, the rearward camera 10B is mounted above the lamp unit 13 placed at the rear end of the frame 3, in other words, being provided underneath region of the vessel 4 and at a fore position of the rear end of the vessel 4. Therefore, as shown in FIG. 10, the rearward camera image includes components placed under the vessel 4. And, since the rearward camera 10B is placed at rearward and higher position as much as possible, imaging may be extended broader space A to the underneath region of the vessel 4. With respect to the example shown in FIG. 10 of the rearward camera image, the image includes partially of the opposite link mechanisms 12L and 12R, the opposite rear wheels 6 and the axle 11. In this connection, since image of rearward camera image of the rearward camera 10B does not be corrected distortion in the state as shown in FIG. 10, the displayed image is included distortion in the link mechanisms 12L and 12R, and the rear wheels 6. Further, the displayed image of the axle 11 also bears distortion partially. The rearward image may be used after performing the correction of distortion.

In this connection, as hereinbefore explained, the dump truck 1 is a large-sized transportation vehicle, and has a broader space A under the vessel 4. The vessel 4 is relatively protruded rearward direction toward the rear wheel 6, the broader space A is formed over extremely wide range. Therefore, some obstacles such as a workman, a service car or the like may possibly be entered into the space A of under the vessel 4. Therefore, it is important that the operator who is boarded in the cab 2 can be confirmed of the situation under the vessel 4.

Therefore, the rearward camera 10B is adapted to enter into the field of view not only for the dump truck 1 but also under area of the vessel 4. However, it is not necessary to enter into the field of view with respect to the forward portion of the vessel 4. Since the axle 11 is a shaft connecting both sides of rear wheels 6, it is not expected that obstacles are likely moved to forward direction over the axle 11. Thus accordingly, the extent of the underneath region is sufficient to have the field of view of the rearward camera 10B on the rear side of the axle 11 in order to cover necessary area in the underneath situation of the vessel 4.

The position of the rearward camera 10B is desired to be placed as high as possible provided not bringing into contact with the vessel 4, and as rear as possible within the extent of fore side of the rear wheel 6. By so constructing, the wide area of the underneath region of the vessel 4 is brought into view field for the operator by looking down the underside of the vessel 4. While, the dump truck 1 runs on the irregular ground so that violent vibration is caused during the travel. Thus vibration is transmitted to the rearward camera 10B, thus being retarded factor for smooth imaging operation.

In the constitution of the dump truck 1, the frame 3 is a structure for foundation of the dump truck 1, thus resulting to affect least vibration. Therefore, the lamp unit 13 is firmly secured to the rear end of the frame 3, thereby being suppressed vibration for the lamp unit 13. And, the vibration for transmitting to the rearward camera 10B can be eliminated by firmly fixed the camera mount 17 on the lamp unit 13. Thereby, the rearward camera 10B can be taken image in normal state.

In this connection, the lamp unit 13 composed of the winker lamp 14 and the back light lamp 15, light is emitted at the time of lightened or blinking these lamps. Incident light L which is directly entered into the lens 18 of the rearward camera 10B is harmful light for image displayed on the screen 25 to becomes improper image. However, the shield plate 16 is provided between the lamp unit 13 and the rearward camera 10B. The shield plate 16 has a function to block the incident light from entering to the rearward camera 10B. Thus, harmful light is not entered to the lens 18.

Especially, the dump truck 1 is traveled backward direction in night, illumination light is supplied for backward direction by turning on the back light lamp 15. The light L emitted from the back light 15 has high intensity, therefore when the light L is directly entered into the lens 18, the image taken from the rearward camera 10B cannot be attained so much the normal quality in the presence of harmful light. While, the light L is not entered directly to the lens 18 due to provision of the shield plate 16 between the lamp unit 13 and the camera 10B. Thereby, the image taken by the rearward camera 10B maintains the normal quality.

Therefore, the operator can precisely recognize the backward situation of the dump truck 1 and underneath situation of the vessel 4 at the night time travel, because the rearward of the dump truck 1 is lightening and the image which is taken by the rearward camera 10B can be displayed on the screen 25 of the monitor 24. Thereby, the operator can operate properly the dump truck 1 at the time of movement to rearward direction in night with viewing of the screen 25.

In this connection, the shield plate 16 is elongated toward rearward direction, extension degree of the shield plate 16 is preferably to be as great as possible for the sake of blocking the incident light L of the lamp unit 13 from entering directly into the lens 18. However, the view field of the rearward camera 10B becomes to be significantly narrowed when the shield plate 16 is projective excessively. As explained before, the rearward camera 10B is necessitated to be entered into the field of view partially of the axle 11 (rearward end), therefore the shield plate 16 should not be extended without limitation so as not to bring out of view the axle 11 for the rearward camera 10B obstructed by the shield plate 11.

For this reason, extent of the projection length is limited for the shield plate 16. That is to say, the shield plate 16 is extended forwardly to the extent up to enter the field of view of the rearward camera 10B into the axle 11. The shield plate 16 can be extended forward to a desired position within the limit that the axle 11 should not be entered in the field of view for the rearward camera 10B. In particular, the shield plate 16 is extended forwardly as much as possible under the condition that the axle 11 is certainly entered in the field of view for the rearward camera 10B. By so constructing, the adverse effect by emitted light L from the lamp unit 13 can be suppressed.

The rearward image taken from the rearward camera 10B which is thus improved the image quality in the image correction section 31 is outputted to the display image creation section 35. Since the first display mode is selected by the display mode controlling section 36, the display image creating section 35 makes to display the rearward camera image as shown in FIG. 10 on the screen 25. The operator can confirm precisely the situation of rearward of the dump truck 1 and underneath region of the vessel 4 by the view of the screen 25.

In this instance, the rearward camera 10B is provided at the rearward direction as much as possible and higher position, therefore, the rearward camera image which is shown includes wide range of the space A under the vessel 4. The partially (rearward end) of the axle 11 is included in the view field of the rearward camera 10B. Due to an obstacle such as a service car, a workman or the like does not move forwardly beyond the axle 22, the operator can sufficiently confirm merely by the rearward camera image shown on the screen 25.

Further, the shield plate 16 is placed between the lamp unit 13 and the rearward camera 10B. Due to the shield plate 16 is extended up to the limit position that the rear end of the axle 11 is included in the field of view for the rearward camera 10B, the image from the rearward camera 10B includes essentially the rear end of the axle 11. At the time of imaging by the rearward camera 10B, the adverse effect of the incident light L can be suppressed to minimum by the presence of the shield plate 16, as a result ensuring to attain normal image. At the same time, the axle 11 is partially appeared in the rearward camera image by restricting the possible extended position of the shield plate 16. Thereby, sufficient safety and the normality in imaging can be realized simultaneously.

In the next place, the second display mode is explained hereafter. The second display mode is to display the rearward camera image and composite bird's eye view image are shown simultaneously on the divided display areas of the screen 25. The screen 25 is divided into two display areas 25A and 25B, the display area 25A showing the rearward camera image, while the display area 25B showing the composite bird's eye view image. In this embodiment, the display areas 25A and 25B are arranged side by side in the transverse direction with 1:1 ratio, although the ratio of respective display areas can be set arbitrary.

As shown in FIG. 8, the image correction section 31 performs the correction for improving the image quality with respect to images taken by the forward camera 10F, the rearward camera 10B, the right side camera 10R and the left side camera 10L. The rearward camera image is outputted to display image creating section 35, while the forward camera image, the rearward camera image, the right side camera image and the left side camera image are outputted to the view point conversion section 32. The view point conversion section 32 performs to convert these four camera images to create virtual plan view images (bird's eye view images). Thereby, four individual bird's eye view images consisting of a forward bird's eye view image, a rearward bird's eye view image, a right side bird's eye view image and a left side bird's eye view image.

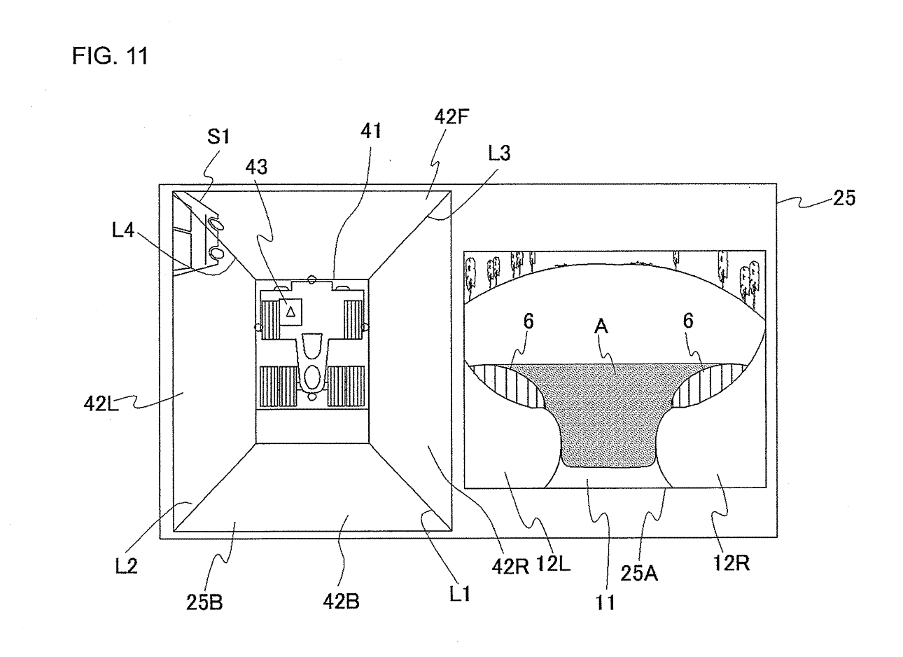

These four bird's eye view images are outputted to the image composing section 34. The image composing section 34 captures from the symbol image storage section 33 which is stored the symbol image. In addition, respective individual bird's eye view images are composed around the symbol image. Therefore, composite bird's eye view image is created. In other words, the forward bird's eye view image 42F, the rearward bird's eye view image 42B, the right side bird's eye view image 42R and the left side bird's eye view image 42L are composed around the symbol image 41 as shown in FIG. 11. Boundary lines L1 to L4 are further composed for making division of respective bird's eye view images. A fore side mark 43 is interposed for indicating the forward direction of the dump truck 1 on the symbol image at the position corresponding to the cab 2. The composite bird's eye view image thus composed in the image composing section is outputted to the image composing section 34.

The display mode controlling section 36 is selected the second display mode, and the selection transferred to the display mode creating section 35. The composite bird's eye view image and the rearward camera image are inputted to display image creating section 34, thereby creating images of rearward camera image for displaying the screen 25 on the display area 25A and of the composite bird's eye view image on the display area 25B of the screen 25, and these images being outputted to the screen 25. Then, the screen 25 is displayed, as shown in FIG. 10, the rearward camera image on the display area 25A and the composite bird's eye view image on the display area 25B.

The composite bird's eye view image shown on the display area 25B is indicated the situation of the surrounding the dump truck 1, therefore, when a certain obstacle is approached to the dump truck 1, the distance between the obstacle and the dump truck 1 can be clearly recognized. In FIG. 11, an obstacle S1 is approached to the dump truck 1, the operator can clearly be aware of the distance between the obstacle S1 and the dump truck 1

In this connection, the composite bird's eye view image is a virtual image view from upper view point to downwardly. Therefore, this display mode is very advantageous in respect that the operator recognizes the surrounding situation of the dump truck 1, but unable to display the underneath situation of the vessel 4 in the composite bird's eye view image. Thus accordingly, the rearward camera image is shown on the display area 25A. In other words, the composite bird's eye view image and the rearward camera image are shown at the same time on the screen 25. The rearward camera image is, as explained above in the first display mode, included a part of the axle 11. And, the rearward camera image is the image comprising a wide space A under the vessel 4.

Therefore, by displaying the composite bird's eye view image and the rearward camera image, the operator can recognize clearly the situation around the dump truck 1 and the under space A of the vessel 4. As explained above, the rear end of the axle 11 is included in the rearward camera image. There is no obstacle to be moved toward the forward position to the axle 11, thus the rearward camera image is contributed to secure the safety sufficiently. In addition, around the dump truck 1 is recognized from the composite bird's eye view image. Therefore, the underneath area of the vessel 4 can be recognized, and at the same time, around the dump truck 1 is also able to be recognized, thus resulting to secure the safety in high quality.

While, the monitor 24 provided in the cab 2 is small in size. Due to ensuring to the operator boarded in the cab 2 to have the visibility of forward direction 2, the monitor 24 is used to have large in size, thereby bringing detrimental result that the visual field being restricted. Therefore, the size of the monitor 24 should be reduced, thereby causing the screen 24 becoming small in size.

When the screen 25 is divided into many parts, various information can be indicated, while the visibility being deteriorated extremely by being increased divided number for the screen 25 due to small in size. Therefore, the divided number of the screen 25 is preferably two to four. In the present embodiment, the division number is two so that rearward camera image and bird's eye view image are simultaneously displayed, thus securing safety sufficiently.

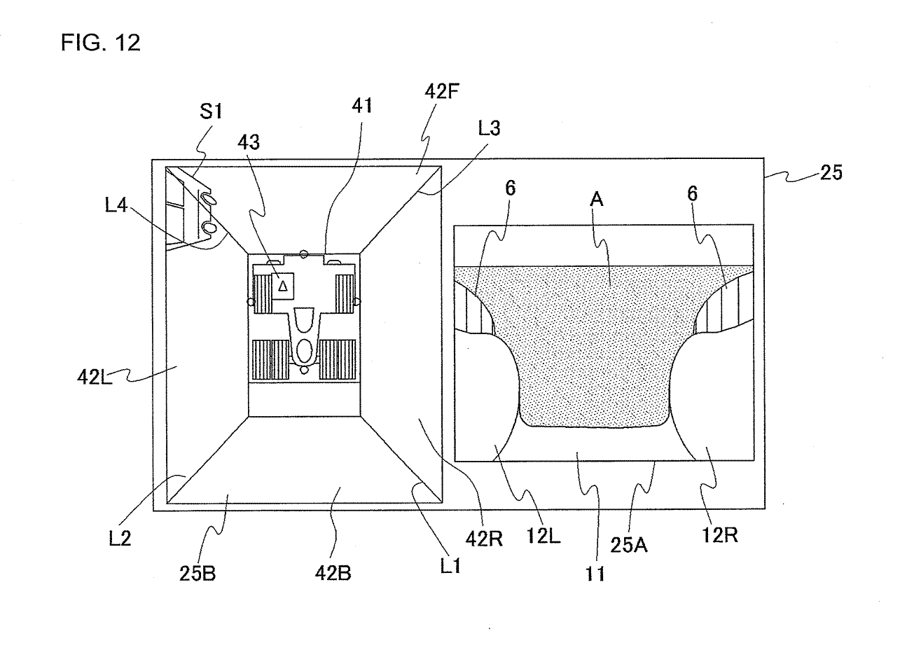

In the next place, an example is explained as the second display mode for the rearward camera image in enlarged state. FIG. 12 shows the enlarged rearward camera image in the display area 25A and the composite bird's eye view image in the display area 25B. The enlarged rearward camera image shown in the display area 25A is expanded region of the underneath space A of the vessel 4 and surrounding thereof. In the second display mode, the display areas 25A and 25B are small in size due to divided aspect of display.

For this purpose, the image enlarging section 37 of the display controller 30 performs a process for enlarging a near portion of the space A of the rearward camera image in the displayed image of the display image creating section 35. The image enlarging section 37 is connected to a setting terminal with a wire connection for setting the position and angle of the rearward camera 10B, thereby allowing to set dimensions in respective components of the vehicle body and the like to identify the space A in the rearward camera image. The rearward camera image can be enlarged in the space A. This is the rearward enlarged image. Although the rearward camera 10B is designed to take imaging the rearward direction of the dump truck 1, in accordance with the present embodiment, the underneath space A is adapted to be displayed so as to make recognition of the situation of the underneath area of the vessel 4.

As explained above, the operator can understand the situation of underneath space A of the vessel 4 in the excellent manner by enlarging the image of the underneath space A of the vessel 4. However, the far distant situation from the dump truck 1 is not shown by the enlarged rearward camera image. While, the composite bird's eye view image is shown in addition to the rearward camera image. The situation of rearward field can be recognized from the composite bird's eye view image, even if the rearward field is not shown in the enlarged rearward camera image. Therefore, there is no situation not to confirm the rear field of the dump truck 1 even if showing the underneath space A of the vessel 4 in the enlarged scale.

The underneath situation of the vessel 4 can be recognized from the enlarged rearward camera image, and around situation of the dump truck 1 can be recognized from the composite bird's eye view image. By so constructing, the operator has sufficient information for operating to travel the dump truck 1, thus ensuring the safety in high degree on travel.

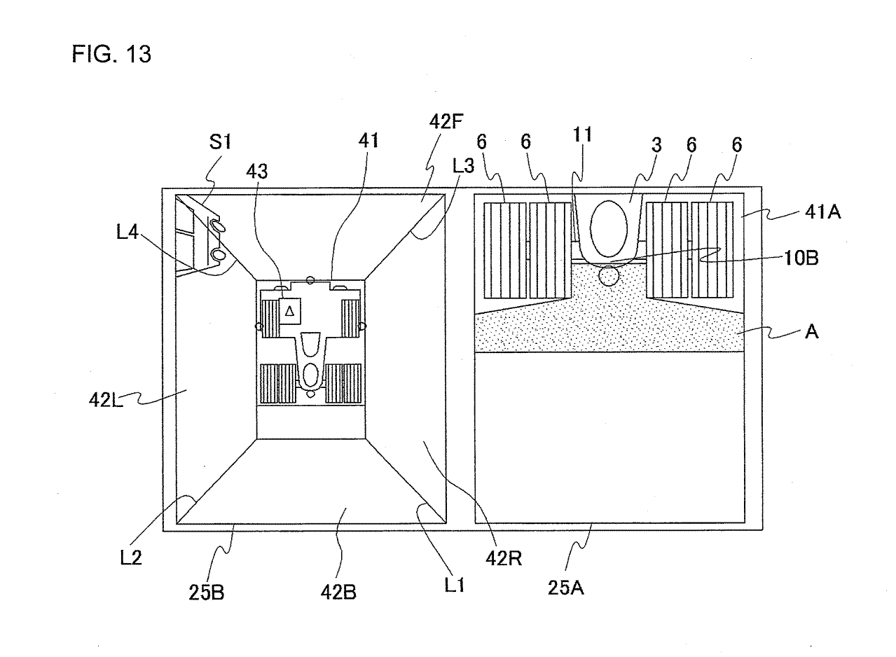

In the next place, an example is referred to display the composite bird's eye view image and an enlarged rearward bird's eye view image on the screen 25. As shown in FIG. 13, the enlarged rearward bird's eye view image is shown on the display area 25A and the composite bird's eye view image is shown on the display area 25B. The individual bird's eye view image is displayed in an enlarged at the place of near the underneath space A of the vessel 4. The image enlarging section 37 of the display controller 20 performs to enlarge the near the space A of the rearward bird's eye view image.

Further, as shown in FIG. 13, the enlarged rearward bird's eye view image is shown on the display area 25A. In this figure, a symbol image 41 is shown as a partial symbol image 41A. As explained hereinbefore, due to the fact that the rearward camera 10B includes the axle 11 partially in the field of view, the image which is enlarged the portion of the space A in the underneath region of the vessel appeared in FIG. 13.

Thus accordingly, the composite bird's eye view image and the rearward bird's eye view image are displayed. The surrounding situation of the dump truck 1 can be recognized from the composite bird's eye view image. The operator can recognize the situation underneath of the space A of the vessel 4 by the enlargement of this space A at the underneath region of the vessel 4 in the rearward bird's eye view image. The display area 25A which is shown is a enlarged rearward bird's eye view image, while the display area 25B is shown the same size with the composite bird's eye view image (that is, composite bird's eye view image itself). Thus accordingly, the visibility of the operator is improved in quality by same size images for the display area 25A and the display area 25B.

In the next place, processing of the dump truck 1 at the time of traveling operation is explained hereafter. As explained before, the shift lever 50 is provided in the cab 2, an operator controls for traveling of the dump truck 1 with the shift lever 50. The shift lever 50 has forward position, neutral position and backward position, whether or not start to travel the dump truck 1 and the travel direction are determined by the position of the shift lever 50. Information as to the position of the shift lever 50 (shift lever information) is communicated to the vehicle controller 40, then the vehicle controller 40 outputs the shift lever information to the display controller 30 as one of the vehicle information.

When the shift lever is operated to backward position, such signal is transferred to the vehicle controller 40, then outputted to the display controller 40. The display controller 30 makes control the screen 25 to display an image of the first display mode, the second display mode, or the like. On the contrary, at the time of the shift lever 50 is positioned at the neutral position or forward position, such signal is transferred to the vehicle controller 40, after then outputted to the display controller 40. The display controller 30 may control the screen 25 not to display any of image of the first display mode, the second display mode, or the like.

That is to say, when the shift lever 50 is shifted to the forward position, the dump truck 1 travels toward forward direction. In this position, there is not particularly necessary to display the rearward situation on the monitor 24. Therefore, the rearward camera image and the rearward bird's eye view image may not be necessary to be displayed at the time of traveling forward direction due to the dump truck 1 does not move toward backwardly. However, when the shift lever 50 is operated to shift from neutral position to backward position, the dump truck 1 moves to backward direction, therefore at the time of neutral position of the shift lever 50, the rearward camera image or the rearward bird's eye view image may be displayed for operating to the first display mode, the second display mode or the like.

### DESCRIPTION OF REFERENCE NUMERALS

1: dump truck
2: cab
3: frame
4: vessel
6: rear wheel
10: camera
10B: rearward camera
10F: forward camera
10L: left side camera
10R: right side camera
11: axle
13: lamp unit
16: shield plate
18: lens
24: monitor
25: screen
30: display controller
19: vehicle controller
31: image correction section
32: view point converting section
33: symbol image storage section
34: image composing section
35: display mode creating section
36: display mode controlling section
37: image enlarging section
40: vehicle controller
41: symbol image
41A: partial symbol image
42B: rearward bird's eye view image
42F: forward bird's eye view image
42L: left side bird's eye view image
42R: right side bird's eye view image

1. A surveillance apparatus for a dump truck having a plurality of rear wheels connected to an axle and having a frame on which a vessel for loading substances is mounted and which is configured to be tilted up and down, comprising:
a lamp unit mounted to a rear end position of the frame at a position under the vessel;
an underneath camera installed at a position above the lamp unit, above the axle connected to the rear wheels, underneath the vessel, and between a rear end of the rear wheels and the axle, the underneath camera positioned to have an angle of view that includes a part of the rear end of the axle connected to the rear wheels, and the underneath camera configured to capture a rearward camera image in a rearward direction of the dump truck with an optical axis directed in an obliquely downward direction, where the rearward camera image includes the part of the rear end of the axle and the rear wheels; and
a display device provided in a cab of the dump truck to show the rearward camera image taken by the underneath camera.

2. The surveillance apparatus for a dump truck according to claim 1, further comprising:
a camera mount disposed to hold the underneath camera at the position above the lamp unit.

3. The surveillance apparatus for a dump truck according to claim 1, further comprising:
a left side camera for imaging a left side of the dump truck and a right side camera for imaging a right side of the dump truck;
a view point converting section to create individual bird's eye view images by converting respective view points to upper view points of the images taken by at least the underneath camera, the left side camera and the right side camera; and
a composite bird's eye view image creating section to create a composite bird's eye view image for composing these individual bird's eye view image, and disposing around a symbol image symbolized the transportation vehicle,
wherein the display device displays the rearward camera image and the composite bird's eye view image on divided display areas on a screen of the display device.

4. The surveillance apparatus for a dump truck according to claim 3, wherein the divided display areas respectively display the composite bird's eye view image and an enlarged image of the rearward camera image.

5. The surveillance apparatus for a dump truck according to claim 3, wherein the divided display areas respectively display the composite bird's eye view image and an enlarged image of the rearward bird's eye view image from the rearward camera image instead of the rearward camera image.

6. The surveillance apparatus for a dump truck according to claim 1, further comprising:
a shield member provided at a position above the lamp unit and under the underneath camera, extended to a position where a part of the rear end of the axle is included within a visual field of the underneath camera, and configured to block light from the lamp unit from entering into the underneath camera.

7. The surveillance apparatus for a dump truck according to claim 1, wherein the underneath camera is installed at the position which is above the lamp unit and between the rear wheels.

8. The surveillance apparatus for a dump truck according to claim 1, wherein the rearward camera image further includes a plurality of link mechanisms which are connected between the frame and the vessel.
